(19) United States
(12) Patent Application Publication
(10) Pub. No.: US 2025/0006148 A1
(43) Pub. Date: Jan. 2, 2025

(54) METHOD OF ESTIMATING VIEW BLIND LEVEL AND METHOD OF PRODUCING VIEW BLIND SPACE

(71) Applicant: NITTO DENKO CORPORATION, Osaka (JP)

(72) Inventors: Yuji Toyota, Osaka (JP); Motosuke Katayama, Osaka (JP)

(73) Assignee: NITTO DENKO CORPORATION, Osaka (JP)

(21) Appl. No.: 18/752,908

(22) Filed: Jun. 25, 2024

(30) Foreign Application Priority Data
Jun. 30, 2023 (JP) 2023-108680

(51) Int. Cl. G09G 3/36; G02B 27/28

(52) U.S. Cl. CPC G09G 3/3611; G02B 27/281; G09G 2320/0626; G09G 2320/068

(57) ABSTRACT

Provided is a method of estimating a view blind level of a space, which is partitioned through use of a partition having a polarizing view blind film including a polarizer bonded thereto, and in which a display is arranged to be blinded when visually recognized through the polarizing view blind film, the method including calculating a predicted value of the view blind level when the display is observed from an outer side of the partition based on the following formula (1):

Y=10\hat{ }(2.27×10⁻²×X1+2.41×10⁻⁴×X2−6.19×10⁻¹) (1)
where Y represents a predicted value (%) of the view blind level, X1 represents an angle (°) formed by a vertical plane including a front direction of the display and a vertical plane including an observation direction, and X2 represents a height (mm) of an observation position.

### BACKGROUND OF THE INVENTION

This application claims priority under 35 U.S.C. Section 119 to Japanese Patent Application No. 2023-108680 filed on Jun. 30, 2023 which is herein incorporated by reference.

### 1. FIELD OF THE INVENTION

The present invention relates to a method of estimating a view blind level and a method of producing a view blind space.

### 2. DESCRIPTION OF THE RELATED ART

In recent years, design that offers a feeling of spatial openness to a working space such as a meeting room or a personal work booth has been widely spread. For example, a large number of working spaces having a part or an entirety of a partition, which partitions a space, formed of a transparent member such as a glass plate or an acrylic plate to produce a feeling of openness have been designed and constructed. In many cases, a laptop personal computer (PC) or a tablet computer is brought into such working space. The working space as described above offers a feeling of openness. Meanwhile, in some cases, there arises a problem in that information displayed on a display of the laptop PC or the like brought into the working space may be peeped by a third party.

Meanwhile, light output from the display of the laptop PC or the like is linearly polarized light in many cases. Thus, as a method of solving a peeping problem, for example, in U.S. Pat. No. 6,552,850, there has been proposed that a partition including a polarizing film arranged so that the polarization direction of light to be output and an absorption-axis direction become parallel to each other is arranged between the display and the third party, to thereby make information displayed on the display invisible from an outside (hereinafter making information displayed on the display invisible is sometimes referred to as “blinding (the display)”, “view blind function”, and the like).

### SUMMARY OF THE INVENTION

In a space to which a polarizing view blind film is applied, a view blind function is weak depending on a place, and information displayed on a display may be able to be visually recognized from outside of the space. Such problem is more conspicuous in a small-scale space for personal use or for a small number of people (a state in which information displayed on a display is visually recognized from outside of a space to which a polarizing view blind film is applied is hereinafter sometimes referred to as “view blind being eliminated” and the like).

The present invention has been made to solve the related-art problem described above, and has a primary object to provide a method of estimating a view blind level of a space in which a display is arranged to be blinded when visually recognized through a polarizing view blind film.

The inventors of the present invention have found that the height of an observation position (point of view) and the observation angle with respect to a display greatly influence the view blind function at the observation position, and have conceived that the view blind level at any observation position can be predicted based on the height of the observation position and the observation angle with respect to the display. Thus, the present invention has been completed.

[1] According to one aspect of the present invention, there is provided a method of estimating a view blind level of a space, which is partitioned through use of a partition having a polarizing view blind film including a polarizer bonded thereto, and in which a display is arranged to be blinded when visually recognized through the polarizing view blind film,
the method including calculating a predicted value of the view blind level when the display is observed from an outer side of the partition based on the following formula (1):

$$Y = {10}^{⋀} ( 2.27 \times {10}^{- 2} \times X 1 + 2.41 \times 1 {0}^{- 4} \times X 2 - 6.19 \times 1 {0}^{- 1} ) \qquad ( 1 )$$

where Y represents a predicted value (%) of the view blind level, X1 represents an angle (°) formed by a vertical plane including a front direction of the display and a vertical plane including an observation direction, and X2 represents a height (mm) of an observation position.

[2] The method according to the above-mentioned item [1] may further include estimating an observation position at which the predicted value of the view blind level does not satisfy a predetermined reference value to be a view blind elimination position.

[3] In the method according to the above-mentioned item [1] or [2], the space may have a width of 3,000 mm or less, a depth of 3,000 mm or less, and a height of 3,000 mm or less.

[4] According to another aspect of the present invention, there is provided a method of producing a view blind space, including: estimating a view blind elimination position in a space, which is partitioned through use of a partition having a polarizing view blind film including a polarizer bonded thereto, and in which a display is arranged to be blinded when visually recognized through the polarizing view blind film, by the method of the above-mentioned item [2]; and compensating for a view blind function at the view blind elimination position.

[5] In the method according to the above-mentioned item [4], the compensating for a view blind function may be performed by covering the view blind elimination position with a non-permeable member or a semi-permeable member, arranging a non-permeable partition or a semi-permeable partition between the display and the view blind elimination position, or forming the view blind elimination position into a mosaic style.

[6] According to still another aspect of the present invention, there is provided a method of predicting brightness information, including: (i) measuring brightness of a display arranged inside a space partitioned through use of a partition having a polarizing view blind film including a polarizer bonded thereto from a plurality of measurement positions on an outer side of the partition; (ii) applying machine learning by using brightness information based on the brightness of the display measured at the plurality of measurement positions as an object variable and using an angle formed by a vertical plane including a front direction of the display and a vertical plane including a measurement direction and a height of the measurement position as explanatory variables, to thereby provide a prediction formula of predicting the brightness information at any position on the outer side of the partition; and (iii) substituting the explanatory variables at a prediction target position into the prediction formula to predict the brightness information at the predication target position.

According to an embodiment of the present invention, the view blind level when the display is observed from any appropriate observation position on the outer side of the partition can be predicted based on the height of the observation position and the observation angle with respect to the display. In addition, according to the embodiment of the present invention, the view blind elimination position can be estimated based on the above-mentioned prediction.

### BRIEF DESCRIPTION OF THE DRAWINGS

FIG. 1 is a schematic view for illustrating a configuration of a surface light source device.

FIG. 2A and FIG. 2B are an explanatory schematic plan view and an explanatory schematic side view for illustrating the brightness measurement of an output surface of the surface light source device, respectively.

FIG. 3A and FIG. 3B are an explanatory schematic plan view and an explanatory schematic side view for illustrating the brightness measurement of the output surface of the surface light source device, respectively.

FIG. 4 is an explanatory schematic plan view for illustrating the brightness measurement of the output surface of the surface light source device.

FIG. 5 is an explanatory schematic plan view for illustrating the brightness measurement of the output surface of the surface light source device.

FIG. 6A is a predicted and actual plot of predicted values based on formula (1a) and actually measured values, and FIG. 6B is a predicted and actual plot of predicted values based on formula (1) and actually measured values.

FIG. 7A and FIG. 7B are each an explanatory schematic view for illustrating one embodiment of the present invention.

FIG. 8A and FIG. 8B are each an explanatory schematic view for illustrating one embodiment of the present invention.

FIG. 9 is a schematic sectional view for illustrating a configuration of a polarizing view blind film which can be used for producing a view blind space.

### DESCRIPTION OF THE EMBODIMENTS

Typical embodiments of the present invention are described below. However, the present invention is not limited to these embodiments. The embodiments may be appropriately combined with each other except for the case that is clearly inappropriate. For better visualization, the accompanying drawings are schematic. Thus, a thickness and a size of each of constituent elements and a ratio of, for example, the thicknesses of the constituent elements in the drawings are different from actual values.

A. Method of estimating View Blind Level

According to an embodiment of the present invention, there is provided a method of estimating a view blind level of a space, which is partitioned through use of a partition having a polarizing view blind film including a polarizer bonded thereto, and in which a display is arranged to be blinded when visually recognized through the polarizing view blind film. The method of estimating a view blind level according to the embodiment of the present invention includes calculating a predicted value of the view blind level when the display is observed from an outer side of the partition based on the following formula (1).

$$Y = {10}^{⋀} ( 2.27 \times {10}^{- 2} \times X 1 + 2.41 \times 1 {0}^{- 4} \times X 2 - 6.19 \times 1 {0}^{- 1} ) \qquad ( 1 )$$

where Y represents a predicted value (%) of the view blind level, X1 represents an angle (°) formed by a vertical plane including a front direction of the display and a vertical plane including an observation direction, and X2 represents a height (mm) of an observation position.

### The Formula (1) is Described Below.

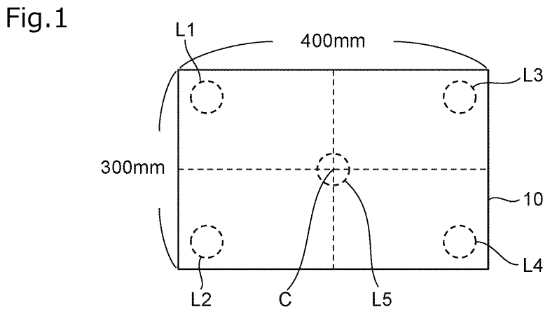

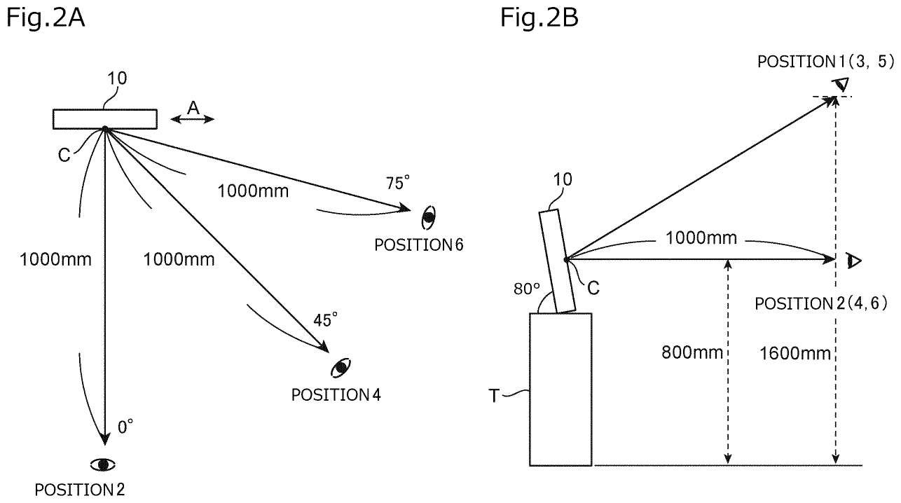

FIG. 1 is an explanatory schematic view for illustrating a surface light source device as an alternative to a display to be arranged inside the above-mentioned space. FIG. 2A to FIG. 5 are each an explanatory schematic view for illustrating the brightness measurement thereof. As illustrated in FIG. 1, a surface light source device 10 has a rectangular output surface measuring 300 mm long by 400 mm wide and includes a total of five light sources L1 to L5 arranged at four corners and a center portion on a back surface side of the output surface. The surface light source device 10 outputs linearly polarized light from the output surface.

FIG. 2A and FIG. 2B are an explanatory schematic plan view and an explanatory schematic side view for illustrating the brightness measurement of the surface light source device, respectively. As illustrated in FIG. 2B, the surface light source device 10 was arranged on a worktable T at an inclination of 10° so that the height of a center C thereof was 800 mm and the angle of the output surface with respect to a horizontal plane was 100°. Then, the brightness of the surface light source device 10 was measured at a total of six observation positions. The observation positions include: three positions having different angles with respect to a vertical plane including a front direction of the output surface at a distance of 1,000 mm from the center C of the output surface of the surface light source device 10; and three positions having heights different from those of the above-mentioned three positions. Specifically, as illustrated in FIG. 2A and FIG. 2B, three positions (positions 2, 4, and 6; any of the positions had a height of 800 mm) having angles of 0°, 45°, or 75° with respect to the front direction (in other words, a direction orthogonal to a lateral direction (arrow A direction) of the output surface) of the output surface in plan view and having the same height as that of the center C at a distance of 1,000 mm from the center C; and three positions (position 1: 0°, position 3: 45°, position 5: 75°; any of the positions had a height of 1,600 mm) positioned 800 mm above the above-mentioned positions were set to observation positions. The measurement was performed with a brightness meter “LS-150” manufactured by Konica Minolta, Inc. The brightness measured at each measurement position is shown in Table 1.

TABLE 1

| Position | 1 | 2 | 3 | 4 | 5 | 6 |
|---|---|---|---|---|---|---|
| Brightness | 220 | 219 | 195 | 176 | 111 | 64 |
| (cd/m²) | | | | | | |

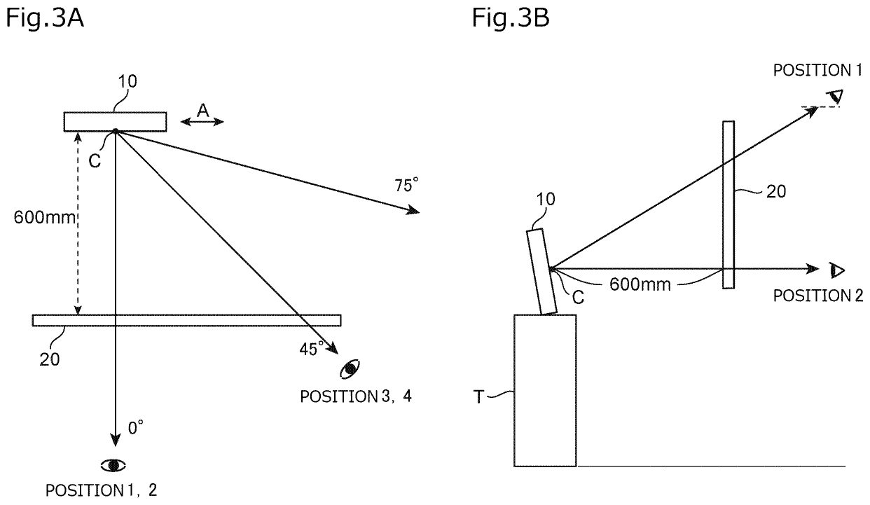

Next, as illustrated in FIG. 3A and FIG. 3B, a polarizing view blind film 20 was arranged so that the distance in a direction of the position 2 from the center C of the output surface of the surface light source device 10 was 600 mm and the principal surface was vertical. An absorption-axis direction of a polarizer included in the polarizing view blind film 20 and a polarization direction of the linearly polarized light output from the surface light source device 10 were parallel to each other. Under such configuration, the brightness of the surface light source device 10 through the polarizing view blind film 20 was measured at the positions 1 to 4. As the polarizing view blind film 20, a polarizing plate (“TEG1465DUHC”, single layer transmittance: 43%, polarization degree: 99.9%, manufactured by Nitto Denko Corporation) including a polarizer and a protective layer formed on each side of the polarizer was used.

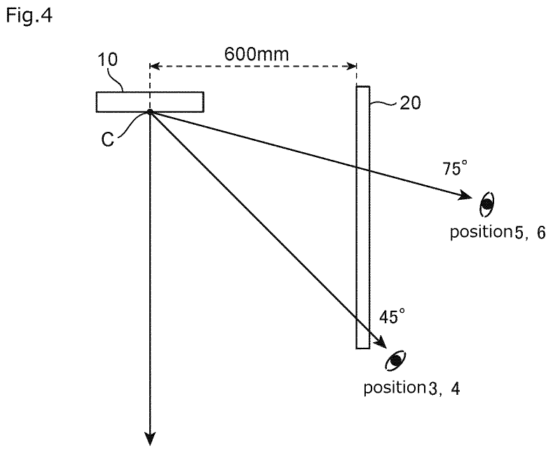

Further, as illustrated in FIG. 4, the polarizing view blind film 20 was arranged so that the distance in a lateral direction of the output surface from the center C of the output surface of the surface light source device 10 was 600 mm and the principal surface was vertical. The absorption-axis direction of the polarizer included in the polarizing view blind film 20 and the polarization direction of the linearly polarized light output from the surface light source device 10 were parallel to each other. Under such configuration, the brightness of the surface light source device 10 through the polarizing view blind film 20 was measured at the positions 3 to 6.

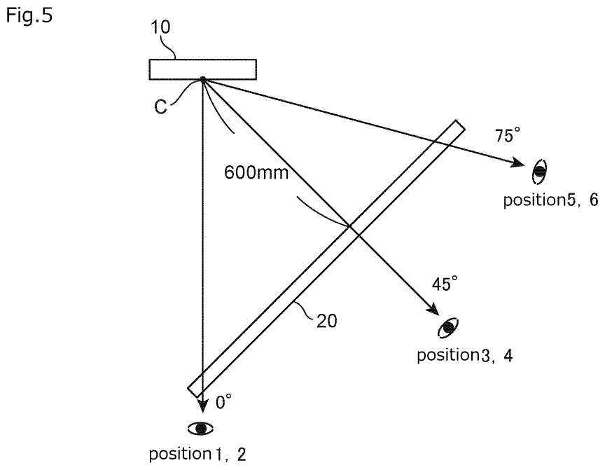

Further, as illustrated in FIG. 5, the polarizing view blind film 20 was arranged so that the distance in a direction of the position 4 from the center C of the output surface of the surface light source device 10 was 600 mm and the principal surface was vertical. The absorption-axis direction of the polarizer included in the polarizing view blind film 20 and the polarization direction of the linearly polarized light output from the surface light source device 10 were parallel to each other. Under such configuration, the brightness of the surface light source device 10 through the polarizing view blind film 20 was measured at the positions 1 to 6.

A ratio of brightness 2 measured through the polarizing view blind film to brightness 1 measured without the polarizing view blind film (brightness 2/brightness 1×100) at each measurement position in each configuration was calculated as a view blind level (%). The view blind level (%) having a smaller value means the state in which the output surface is more satisfactorily blinded. View blind levels and values obtained by converting the view blind levels to the common logarithm (Log 10) are shown in Table 2.

TABLE 2

| | | | | | View | Value |
|---|---|---|---|---|---|---|
| | | | | | blind | converted |
| Config- | | Angle | Height | Distance | level | to Log |
| uration | Position | (°) | (mm) | (mm) | (%) | 10 |
| FIG. 3A | 1 | 0 | 1,600 | 600 | 0.1 | −1 |
| and | 3 | 45 | 1,600 | 848.5 | 6 | 0.778 |
| FIG. 3B | 2 | 0 | 800 | 600 | 0.05 | −1.301 |
| | 4 | 45 | 800 | 848.5 | 1.7 | 0.230 |
| FIG. 4 | 3 | 45 | 1,600 | 848.5 | 18.5 | 1.267 |
| | 5 | 75 | 1,600 | 621.2 | 59 | 1.771 |
| | 4 | 45 | 800 | 848.5 | 4.3 | 0.633 |
| | 6 | 75 | 800 | 621.2 | 22 | 1.342 |
| FIG. 5 | 1 | 0 | 1,600 | 848.5 | 2.1 | 0.322 |
| | 3 | 45 | 1,600 | 600 | 14 | 1.146 |
| | 5 | 75 | 1,600 | 848.5 | 43 | 1.633 |
| | 2 | 0 | 800 | 848.5 | 0.5 | −0.301 |
| | 4 | 45 | 800 | 600 | 3.4 | 0.531 |
| | 6 | 75 | 800 | 848.5 | 16 | 1.204 |

Regarding 13 pieces of measurement data among 14 pieces of measurement data shown in Table 2, AI was allowed to perform machine learning by using a value converted to Log 10 of the view blind level (%) as an object variable and using the distance between the output surface of the surface light source device and the polarizing view blind film, the angle formed by the vertical plane including the front direction of the output surface and the vertical plane including the observation direction, and the height of the observation position as explanatory variables, to thereby create a prediction formula, and the predicted value and the remaining one actually measured value were compared to each other under the measurement condition of the remaining one piece of measurement data. Such operation was performed on each of the 14 pieces of measurement data to converge the prediction formula, to thereby provide the following formula (1a).

$${Y}^{′} = 2.46 \times 1 {0}^{- 2} \times X 1 + 5.74 \times 1 {0}^{- 4} \times X 2 + 1.06 \times 1 {0}^{- 3} \times X 3 - 1 \text{.89} \qquad ( 1 a )$$

where Y′ represents a predicted value (%) of a value converted to Log 10 of the view blind level, X1 represents an angle (°) formed by the vertical plane including the front direction of the output surface of the surface light source device and the vertical plane including the observation direction, X2 represents the height (mm) of the observation position, and X3 represents the distance (mm) between the output surface and the polarizing view blind film.

In addition, through use of the data set shown in Table 2, the construction of a prediction model and the selection of variables were performed by Lasso regression using the value converted to Log 10 of the view blind level (%) as an object variable and using the distance between the output surface of the surface light source device and the polarizing view blind film, the angle formed by the vertical plane including the front direction of the output surface and the vertical plane including the observation direction, and the height of the observation position as explanatory variables, and then, the logarithm was converted back to anti-logarithm. Thus, the above-mentioned formula (1) was obtained. As is understood from the formula (1), in the Lasso regression, the weight of the distance between the output surface of the surface light source device and the polarizing view blind film was set to “0”.

When the view blind level was converted to Log 10, data having bias reduced can be obtained, and the prediction formula can be suitably constructed.

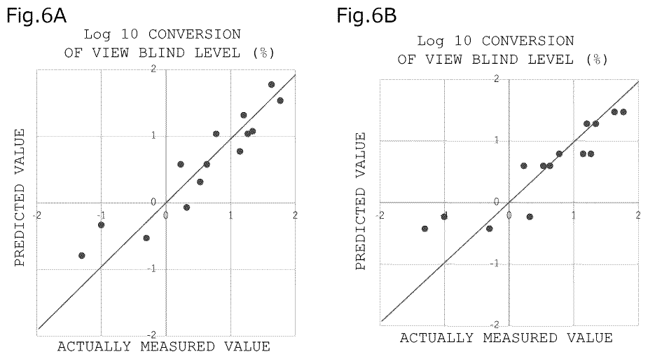

FIG. 6A is a graph in which the horizontal axis represents the values converted to Log 10 of the actually measured values of the view blind levels shown in Table 2 and the vertical axis represents predicted values of the values converted to Log 10 of the view blind levels calculated based on the formula (1a). FIG. 6B is a graph in which the horizontal axis represents the values converted to Log 10 of the actually measured values of the view blind levels shown in Table 2 and the vertical axis represents predicted values of the values converted to Log 10 of the view blind levels calculated based on the formula (1). In the graphs of FIG. 6A and FIG. 6B, the accuracies (R2) of the prediction formulae are 0.88 and 0.83, respectively, and hence it can be recognized that the prediction accuracy is sufficiently high. From this, it is understood that the values converted to Log 10 of the predicted values of the view blind levels based on the formula (1a) and the formula (1) are reasonable.

With the method of estimating a view blind level according to the embodiment of the present invention, when the predicted value of a view blind level is calculated based on the formula (1), the view blind level when the display is observed from any appropriate observation position on the outer side of the partition to which the polarizing view blind film is applied can be estimated. In addition, a predetermined reference value is provided regarding a view blind level, and an observation position at which a predicted value does not satisfy the reference value can be estimated to be a view blind elimination position.

The above-mentioned view blind level may correspond to the ratio of the brightness of the display observed on the outer side of the partition to which the polarizing view blind film is applied with respect to the brightness of the display observed on the inner side. Thus, when the reference value is set to be lower, a higher view blind property can be ensured. The reference value of the view blind level may be appropriately set in accordance with the application, size, and required view blind level of the space, the kind of a display to be arranged inside the space, and the like. The reference value may be set to, for example, 30% or less, and may be 20% or less, 10% or less, or 5% or less. In one embodiment, the reference value may be set so that the brightness of the display at the time of white display measured at an observation position is, for example, 50 cd/m² or less and also, for example, 30 cd/m² or less. A liquid crystal display or an organic EL display may be used as a display to be arranged. The surface brightness of the display in the front direction at the time of white display may be generally from 70 cd/m² to 160 cd/m².

The size of the space to which the method of estimating a view blind level according to the embodiment of the present invention is applied is not limited as long as the effects of the present invention are obtained. The width of the space may be preferably 3,000 mm or less, for example, from 500 mm to 2,000 mm. The depth of the space may be preferably 3,000 mm or less, for example, from 500 mm to 2,000 mm. The height of the space may be preferably 3,000 mm or less, for example, from 1,500 mm to 2,500 mm. The width of the space may be a length in a direction parallel to the lateral direction of a display to be arranged in the space. The depth of the space may be a length in a direction orthogonal to the width of the space. In addition, the height at which the display is arranged (center height of the display) may be, for example, from 700 mm to 1,100 mm.

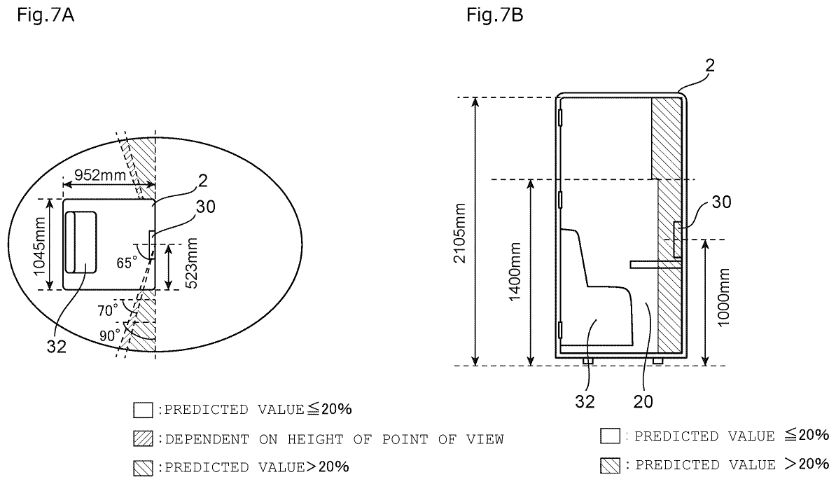

FIG. 7A and FIG. 7B show the results obtained by performing the estimation of a view blind level and the estimation of a view blind elimination position with respect to a one-person work booth to which a polarizing view blind film is applied. In FIG. 7A and FIG. 7B, a work booth 2 has a rectangular parallelepiped shape having a width of about 1,050 mm, a depth of about 950 mm, and a height of about 2,000 mm. A display 30 is mounted on a wall in the width direction of the work booth 2 at a center height of 1,000 mm, and a sofa 32 for a worker is arranged on a side facing the display 30. In addition, almost the entire surface of each of walls on both sides of the worker is formed of a transparent member, and a polarizing view blind film 20 is installed so that the absorption-axis direction of a polarizer is parallel to the polarization direction of linearly polarized light output from the display 30. FIG. 7A and FIG. 7B show estimation results when the work booth 2 is seen from above and when the work booth 2 is seen from the right side of the worker, respectively. As illustrated in those figures, in all the regions in which the angle formed by the observation direction and the front direction of the display is more than 70° and 90° or less, the predicted value of a view blind level is more than 20%, and in the regions in which the angle is more than 650 and 70° or less, the predicted value of a view blind level is more than 20% in a portion having a height of 1,400 mm or more. Thus, when the reference value of a view blind level is set to 20% or less, those regions are estimated to be view blind elimination regions.

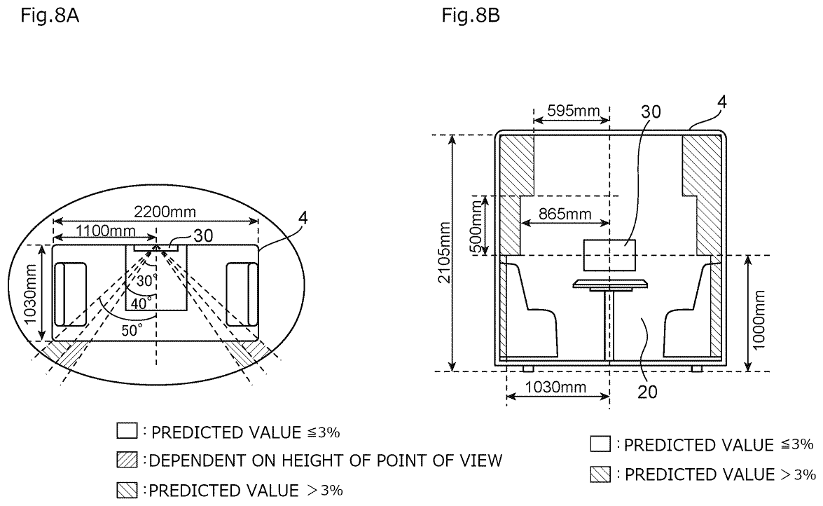

FIG. 8A and FIG. 8B show the results obtained by performing the estimation of a view blind level and the estimation of a view blind elimination position with respect to a two-person work booth to which a polarizing view blind film is applied. In FIG. 8A and FIG. 8B, a work booth 4 has a rectangular parallelepiped shape having a width of 2,200 mm, a depth of 1,030 mm, and a height of about 2,100 mm. The display 30 is mounted on a wall in the width direction of the work booth 4 at a center height of 1,000 mm. Almost the entire surface of a wall on a side facing the display 30 is formed of a transparent member, and the polarizing view blind film 20 is installed so that the absorption-axis direction of the polarizer is parallel to the polarization direction of the linearly polarized light output from the display 30. FIG. 8A and FIG. 8B show estimation results when the work booth 4 is seen from above and when the work booth 4 is seen from the side facing the display, respectively. As illustrated in those figures, in all the regions in which the angle formed by the observation direction and the front direction of the display is more than 40°, the predicted value of a view blind level is more than 3%, and in the regions in which the angle is more than 30° and 40° or less, a portion in which the predicted value of a view blind level is more than 3% emerges in a portion having a height of 1,000 mm or more. Thus, when the reference value of a view blind level is set to 3% or less, those regions are estimated to be view blind elimination regions.

The partition that partitions the space may be a fixed type (e.g., a wall) or a movable type (e.g., a door, a movable partition). In one embodiment, the space is a room having a rectangular shape in plan view and is partitioned by two sets of parallel pairs of partitions (e.g., walls) that are arranged so as to be orthogonal to each other. A part or an entirety of at least one of the partitions partitioning the space is formed so as to be transparent (in other words, so that the inside of the space can be visually recognized) through use of a transparent member, and a polarizing view blind film is bonded to the transparent member. The polarizing view blind film may be bonded to the partition, for example, via an adhesion layer (adhesive layer, pressure-sensitive adhesive layer, or the like).

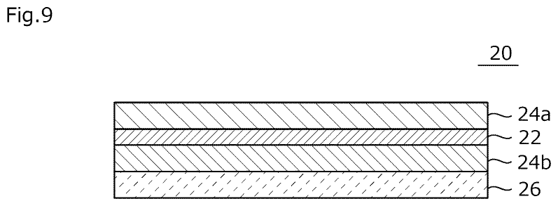

FIG. 9 is an explanatory schematic sectional view for illustrating a configuration of an example of the polarizing view blind film. The polarizing view blind film 20 includes a polarizer 22, a first protective layer 24a formed on one side thereof, and a second protective layer 24b formed on another side thereof. The first protective layer and the second protective layer are bonded to the polarizer, for example, via an adhesion layer (e.g., an adhesive layer). Any one of the first protective layer or the second protective layer may be omitted in accordance with purposes.

The polarizing view blind film 20 may further include a pressure-sensitive adhesive layer 26. With the configuration including the pressure-sensitive adhesive layer, the polarizing view blind film can be bonded to the partition via the pressure-sensitive adhesive layer, and thus installation is easy. Until the polarizing view blind film is used, a release liner may be temporarily bonded to the surface of the pressure-sensitive adhesive layer.

Although not shown, the polarizing view blind film may further include any appropriate functional layer, such as a hard coat layer, an antifouling layer, an antireflection layer, or the like.

The thickness of the polarizing view blind film excluding the pressure-sensitive adhesive layer may be, for example, from 25 μm to 200 μm, preferably from 50 μm to 120 μm.

Any appropriate polarizer may be adopted as a polarizer. The polarizer is typically formed of a polyvinyl alcohol (PVA)-based resin film containing a dichroic substance (e.g., iodine). Examples of the PVA-based resin include polyvinyl alcohol, a partially formalized polyvinyl alcohol, an ethylene-vinyl alcohol copolymer, and an ethylene-vinyl acetate copolymer-based partially saponified product.

The polarizer preferably exhibits absorption dichroism at any one of wavelengths of from 380 nm to 780 nm. The single layer transmittance of the polarizer is preferably from 41.0% to 46.0%, more preferably from 42.0% to 45.0%. The polarization degree of the polarizer is preferably 97.0% or more, more preferably 99.0% or more, still more preferably 99.9% or more.

The single layer transmittance and polarization degree may be measured with, for example, a UV-visible spectrophotometer. A single layer transmittance Ts, a parallel transmittance Tp, and a cross transmittance Tc are measured with a UV-visible spectrophotometer, and a polarization degree P can be determined by the following formula from the resultant Tp and Tc. The Ts, Tp, and Tc are Y values measured by the 2-degree field of view (C light source) of JIS Z8701 and subjected to visibility correction.

$$Polarization degree P ( \% ) = {\{ ( Tp - Tc ) / ( Tp + Tc ) \}}^{1 / 2} \times 100$$

The thickness of the polarizer is typically 20 μm or less, for example, 12 μm or less, preferably 10 μm or less, more preferably from 1 μm to 8 μm, still more preferably from 3 μm to 7 μm.

The protective layer is formed of any appropriate resin film. A material for forming the resin film is typically a cellulose-based resin such as triacetylcellulose (TAC), a cycloolefin-based resin such as polynorbornene, a (meth)acrylic resin, a polyester-based resin, such as polyethylene terephthalate (PET) or polyethylene naphthalate (PEN), a polyolefin-based resin such as polyethylene, or a polycarbonate-based resin. A typical example of the (meth)acrylic resin is a (meth)acrylic resin having a lactone ring structure. The (meth)acrylic resin having a lactone ring structure is described in, for example, JP 2000-230016 A, JP 2001-151814 A, JP 2002-120326 A, JP 2002-254544 A, and JP 2005-146084 A, which are incorporated herein by reference.

The thickness of the protective layer is preferably from 10 μm to 80 μm, more preferably from 12 μm to 40 μm, still more preferably from 15 μm to 35 μm.

B. Method of producing View Blind Space

The method of producing a view blind space according to the embodiment of the present invention includes: estimating a view blind elimination position in a space, which is partitioned through use of a partition having a polarizing view blind film including a polarizer bonded thereto, and in which a display is arranged to be blinded when visually recognized through the polarizing view blind film, by the above-mentioned method of estimating a view blind level; and compensating for a view blind function at the view blind elimination position.

Here, the expression “compensating for a view blind function at the view blind elimination position” means ensuring that the view blind level at the view blind elimination position satisfies the reference value. The compensation for a view blind function at the view blind elimination position may be performed by, for example, covering the view blind elimination position with a non-permeable member (e.g., a member having a total light transmittance of 10% or less) or a semi-permeable member (e.g., a member having a total light transmittance of from 20% to 50%), arranging a non-permeable partition or a semi-permeable partition between the display and the view blind elimination position, or forming (blurring) the view blind elimination position into a mosaic style through use of a retardation film or the like. The view blind elimination position may be entirely covered or may be partially covered to the extent that the display content of the display becomes difficult to be recognized visually.

For example, in the work booth 2 illustrated in FIG. 7A and FIG. 7B, a view blind space in which a view blind level of 20% or less is achieved can be produced by bonding a light-shielding film to a region in which the predicted value of a view blind level is more than 20%.

### C. Method of Predicting Brightness Information

A method of predicting brightness information according to the embodiment of the present invention includes:
(i) measuring brightness of a display arranged inside a space partitioned through use of a partition (polarizing partition) having a polarizing view blind film including a polarizer bonded thereto from a plurality of measurement positions on an outer side of the partition;
(ii) applying machine learning by using brightness information based on the brightness of the display measured at the plurality of measurement positions as an object variable and using an angle formed by a vertical plane including a front direction of the display and a vertical plane including a measurement direction and a height of the measurement position as explanatory variables, to thereby provide a prediction formula of predicting the brightness information at any position on the outer side of the partition; and
(iii) substituting the explanatory variables at a prediction target position into the prediction formula to predict the brightness information at the predication target position.

According to the above-mentioned prediction method, the brightness information on the display arranged in the space at any appropriate position outside the space partitioned through use of a polarizing partition can be predicted. Here, the “brightness information based on the brightness of the display measured at the plurality of measurement positions” in the step (ii) may be the measured brightness itself, the ratio of the measured brightness to the brightness of the display measured in the same positional relationship except that the polarizing partition is not used (e.g., the view blind level described in the section A), a value obtained by converting those values to the logarithm, or the like.

The machine learning in the step (ii) may be typically performed through use of a regression method. The regression method is not particularly limited, and examples thereof include linear regression, Lasso regression, linear ridge regression, Kernel ridge regression, Gaussian process regression, support vector regression, and neural network regression. In addition, the distance between the output surface of the display and the polarizing view blind film, the arrangement angle, the polarization degree of the polarizing view blind film (polarizer), and the like may be added to the explanatory variables.

The method of estimating a view blind level and the method of producing a view blind space according to each of the embodiments of the present invention may be suitably used in, for example, producing a working space which requires information management.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A method of estimating a view blind level of a space, which is partitioned through use of a partition having a polarizing view blind film including a polarizer bonded thereto, and in which a display is arranged to be blinded when visually recognized through the polarizing view blind film,
the method comprising calculating a predicted value of the view blind level when the display is observed from an outer side of the partition, based on the following formula (1):
$$Y = {10}^{⋀} ( 2.27 \times {10}^{- 2} \times X 1 + 2.41 \times 1 {0}^{- 4} \times X 2 - 6.19 \times 1 {0}^{- 1} ) \qquad ( 1 )$$
where Y represents a predicted value (%) of the view blind level, X1 represents an angle (°) formed by a vertical plane including a front direction of the display and a vertical plane including an observation direction, and X2 represents a height (mm) of an observation position.

2. The method according to claim 1, further comprising estimating an observation position at which the predicted value of the view blind level does not satisfy a predetermined reference value to be a view blind elimination position.

3. The method according to claim 1, wherein the space has a width of 3,000 mm or less, a depth of 3,000 mm or less, and a height of 3,000 mm or less.

4. A method of producing a view blind space, comprising:
estimating a view blind elimination position in a space, which is partitioned through use of a partition having a polarizing view blind film including a polarizer bonded thereto, and in which a display is arranged to be blinded when visually recognized through the polarizing view blind film, by the method of claim 2; and
compensating for a view blind function at the view blind elimination position.

5. The method according to claim 4, wherein the compensating for a view blind function is performed by covering the view blind elimination position with a non-permeable member or a semi-permeable member, arranging a non-permeable partition or a semi-permeable partition between the display and the view blind elimination position, or forming the view blind elimination position into a mosaic style.

6. A method of predicting brightness information, comprising:
(i) measuring brightness of a display arranged inside a space partitioned through use of a partition having a polarizing view blind film including a polarizer bonded thereto from a plurality of measurement positions on an outer side of the partition;
(ii) applying machine learning by using brightness information based on the brightness of the display measured at the plurality of measurement positions as an object variable and using an angle formed by a vertical plane including a front direction of the display and a vertical plane including a measurement direction and a height of the measurement position as explanatory variables, to thereby provide a prediction formula of predicting the brightness information at any position on the outer side of the partition; and
(iii) substituting the explanatory variables at a prediction target position into the prediction formula to predict the brightness information at the predication target position.
